(19) United States
(12) Patent Application Publication
(10) Pub. No.: US 2007/0033841 A1
(43) Pub. Date: Feb. 15, 2007

(54) Display for an eyeglass wiping device

(76) Inventor: Jon Kilmer, Warminster, PA (US)

Correspondence Address: Robert E. Cannuscio;Drinker Biddle & Reath LLP, One Logan Square, 18th and Cherry Streets, Philadelphia, PA, 19103-6996, US

(21) Appl. No.: 11/201,517

(22) Filed: Aug. 11, 2005

(51) Int. Cl. G09F 1/08

(52) U.S. Cl. 40/538

(57) ABSTRACT

A display for an eyeglass wiping device simulates wiping motion between the device and an eyeglass lens. The display includes an advertising panel bearing a depiction of an eyeglass lens and a wiping illustration mechanism having a display arm simulating the wiping device. The display arm is pivotably supported such that a head portion of the display arm is located adjacent the depicted eyeglass lens. The wiping illustration mechanism also includes an arm drive preferably including a rocker connected to the display arm such that they pivot together. The rocker has a center of gravity located below a pivot axis to provide a to and fro pivoting motion in pendulum-like fashion. The rocker carries a pair of magnet elements in spaced legs of the rocker for magnetic interaction with an energizable coil that maintains the rocker in a to an fro motion of substantially constant amplitude.

### FIELD OF THE INVENTION

The present invention relates generally to devices for wiping eyeglass lenses, and more particularly to a display for an eyeglass wiping device.

### BACKGROUND OF THE INVENTION

A known device for wiping eyeglass includes a pair of wiping elements supported by a holder. The holder of the wiping device includes a pair of arms arranged in a tongs-like manner and carrying the wiping elements adjacent terminal ends of the arms such that the wiping elements are located in opposing relation to each other. This construction positions the pair of wiping elements for receipt of an eyeglass lens between the wiping elements such that the wiping elements may be brought into contact with the opposite surfaces of the lens.

Known displays include a tray for supporting packaged articles in an upright fashion and an advertising panel portion supported by the tray portion adjacent a rearward side of the tray.

### SUMMARY OF THE INVENTION

The present invention provides a display for an eyeglass wiping device including a pair of wiping elements and a holder having a pair of arms connected to each other at one end and supporting the wiping elements adjacent an opposite end for contact between the wiping elements and opposite surfaces of an eyeglass lens. The display of the present invention simulates wiping motion between an eyeglass wiping device and an eyeglass lens.

According to one aspect of the invention, the display includes an advertising panel having a front surface bearing a depiction of an eyeglass lens and a wiping illustration mechanism attached to the advertising panel. The wiping illustration mechanism includes a display arm simulating the eyeglass wiping device. The display arm includes an elongated body portion and a head portion connected to the body portion. The display arm is pivotably supported such that the head portion of the display arm is located adjacent the eyeglass lens depicted on the advertising panel. The wiping illustration mechanism also includes an arm drive operably connected to the display arm and pivotably driving the display arm with respect to the advertising panel in a to and fro motion simulating a wiping motion of an eyeglass wiping device with respect to an eyeglass lens.

According to another aspect of the invention, the display includes a wiping illustration mechanism having a rocker member pivotably supported at a pivot axis rearwardly of the advertising panel. The rocker member is operably connected to the display arm such that the display arm pivots concomitantly with the rocker member. The rocker member has a center of gravity that is located below pivot axis to provide for a to and fro pivoting motion of the rocker member in pendulum-like fashion.

According to one embodiment of the invention, the rocker member includes a pair of spaced legs located below the pivot axis and a magnet element carried by each of the legs. The display further includes an energizable coil element centrally supported between the spaced legs of the rocker member such that a magnetic interaction between the coil element and the magnet elements drivingly maintains the rocker member in a to and fro pivoting motion with respect to the advertising panel having a substantially constant amplitude.

Preferably the rocker member includes a tab located above the pivot axis to facilitate initiation by a user of a to and fro pivoting motion of the rocker member with respect to the advertising panel.

### BRIEF DESCRIPTION OF THE DRAWINGS

FIG. 1 is a perspective view of a display for a device for wiping eyeglass lenses shown with a panel portion of the display separated from a tray portion.

FIG. 2 is a perspective view illustrating the wiping device of FIG. 1 removed from its packaging and being used to clean an eyeglass lens.

FIG. 3 is a perspective view of the wiping device of FIG. 1 and its packaging.

FIG. 4 is a side elevation view of the panel portion of the display of FIG. 1.

FIG. 5 is a rear view of the panel portion of the display of FIG. 1.

FIG. 6 is a partial side view of the panel portion of the display of FIG. 1 taken along the lines 6-6 of FIG. 5.

### DESCRIPTION OF THE INVENTION

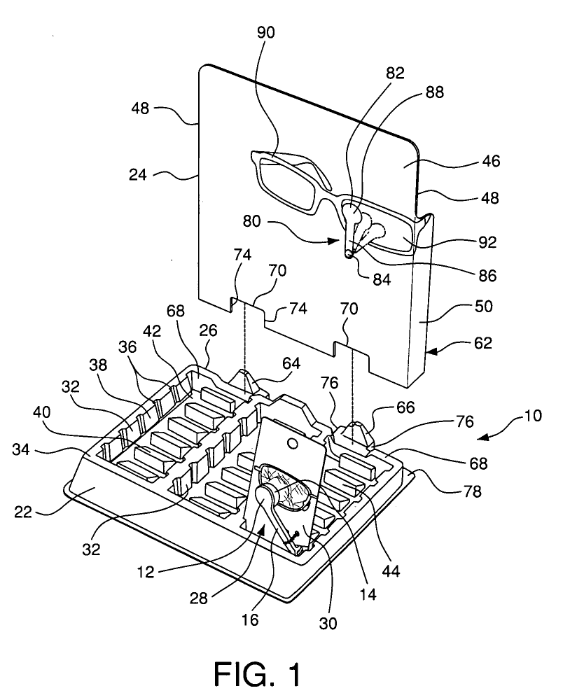

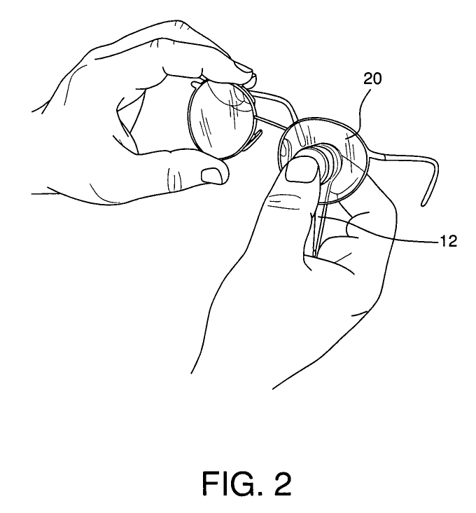

Referring to the drawings, where like numerals identify like elements, there is illustrated in FIG. 1 a display 10 for an eyeglass wiping device 12. Referring to FIGS. 2 and 3, the wiping device 12 associated with the display of FIG. 1 is shown in greater detail. The wiping device 12 is of the handheld type including a pair of wiping elements 14 carried by a holder 16. The holder 16 of wiping device 12 includes a pair of arms 18 connected to each other at one end and supporting the wiping elements 14 adjacent an opposite end of the arms 18 such that the wiping elements 14 are arranged in opposing relation to each other. This construction provides for receipt of an eyeglass lens 20 between wiping elements 14, as shown in FIG. 2, such that the wiping elements 14 may be brought into contact with the opposite surfaces of the lens. The display 10, as described below in greater detail, includes actuated elements to provide a visual illustration to a viewer of the display 10 of the intended manner of using the wiping device 12 for cleaning an eyeglass lens.

Referring again to FIG. 1, the display 10 includes a tray portion 22 and an advertising portion 24 supported by the tray portion 22 at a rearward side 26 of the tray portion 22. The eyeglass wiping device 12 is secured to packaging 28 that, as also seen in FIG. 3, includes a substantially rectangular mount panel 30. As shown, the tray portion 22 of display 10 is adapted to support the packaged devices 10 in a substantially upstanding condition for display of the devices 10. The tray portion 22 defines recessed channels 32 in an upper surface 34 in which the mount panels 30 of the packaged devices are supported. Each of the channels 32 includes slots 36 defined in opposite side walls 38 of the channel 32 for sliding receipt of the mount panels 30 as shown.

The tray portion 22 of display 10 also includes projections 40 formed in each of the channels 32 along a bottom wall 42 of the channel 32. Each of the projections 40 is preferably arranged such that an upstanding front surface 44 of the projection is located slightly forward on the tray portion 22 with respect to an associated pair of the slots 36. This arrangement provides for contact between the front surface 44 of the projection 40 and a rear surface of the mount panel 30 and between a front surface of the mount panel 30 and a forwardly located side wall of the slot 36. In this manner, the projection creates a slight wedging effect on the mount panel 30, which is preferably made from a sufficiently flexible paperboard or cardboard material, to maintain the mount panel 30 in a standing configuration within the associated pair of slots 36 as shown in FIG. 1.

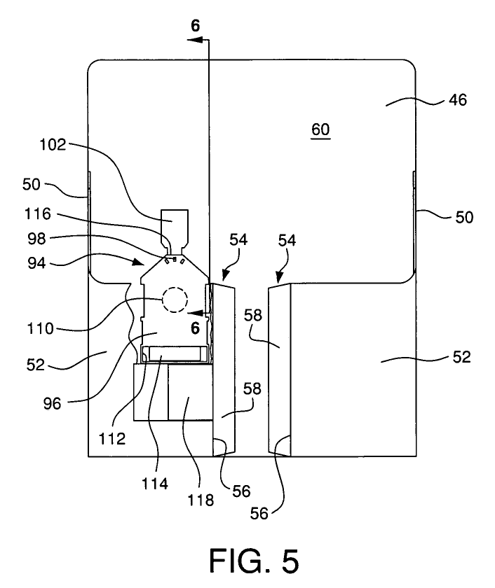

Referring to FIGS. 1 and 4-6, the advertising portion 24 of the display 10 includes a main panel 46, side flaps 50 connected to the main panel 46 along opposite side edges 48 of the main panel 46, and rear flaps 52 connected to the side flaps. The main panel 46 and the side and rear flaps 50, 52 are preferably integrally formed from a cardboard or paperboard material. As shown in FIG. 5, each of the rear flaps 52 preferably includes a terminal end portion 54 that is folded to include a first portion 56 that returns towards the main panel 46 substantially perpendicular to a rear surface 60 of the main panel 46 and a second portion 58 that is parallel to the rear surface 60 and adhesively secured thereto. Arranged in this manner, the side and rear flaps 50, 52 form open-ended box-like configurations 62 with adjacent portions of the main panel 46.

Referring to FIG. 1, the tray portion 22 of display 10 includes first and second projections 64, 66 extending rearwardly from rear walls 68 of the tray 22 that are associated with two of the channels 32. The projections 64, 66 engage the advertising portion 24 of the display 10 for substantially upstanding support of the advertising portion 24. The main panel 46 of the advertising portion 24 includes a pair of notches 70 formed in a lower edge 72 of the main panel 46. Each of the notches 70 in the main panel 46 defines opposite side edges 74 that are spaced for sliding engagement with upstanding side surfaces 76 of the panel-engaging projections 64, 66 of the tray portion 22 such that the projections 64, 66 of the tray portion 22 are received within the box-like configurations 62 of the advertising portion 24. The tray portion 22 also includes a peripheral lip 78 at the rearward side 26 of the tray portion. The peripheral lip 78 of the tray portion 22 is contacted by the lower edge 72 of the advertising portion 24 when the projections 64, 66 are slidingly received within the box-like configurations 62 of the advertising portion 24.

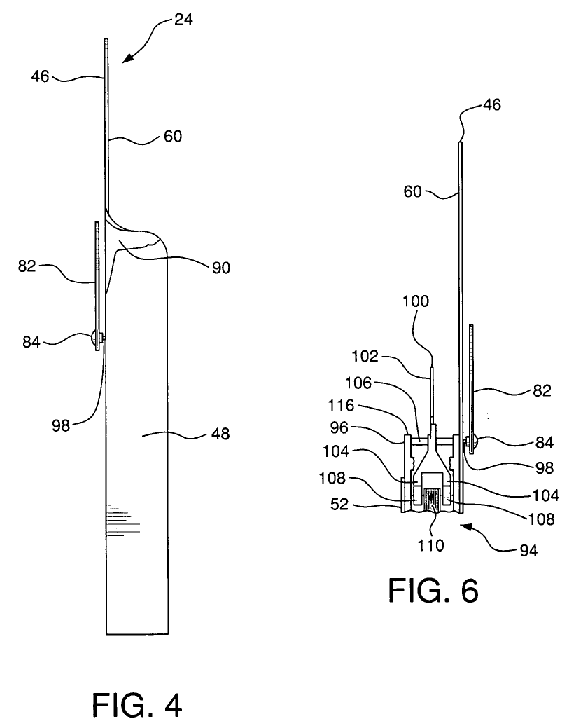

The advertising portion 24 of the display 10 includes a product illustration mechanism 80 adapted to show a viewer of the display 10 the manner in which the eyeglass wiping device 12 is intended to be used to clean an eyeglass lens. Referring to FIGS. 1 and 4, the mechanism 80 includes a display arm 82 and a support pin 84 that is received by the display arm 82 adjacent a lower end of the arm. The display arm 82, which is preferably made from a paperboard or cardboard material, includes an elongated body portion 86 and a substantially circular head portion 88 at an upper end of the display arm 82. The display arm 82 is supported adjacent to an depiction 90, preferably a drawing or image, of a pair of eyeglasses on the main panel 46. As illustrated in FIG. 1, and described in greater detail below, the display arm 82 is moved by the mechanism 80 to simulate a wiping motion of the head portion 88 of display arm 82 with respect to an eyeglass lens portion 92 of the depiction 90.

Referring to FIGS. 5 and 6, the mechanism 80 of the advertising portion 24 of display 10 includes an arm drive 94 having a housing 96 located on the rear surface 60 of the main panel 46. The arm drive 94 also includes an arm support shaft 98 pivotably supported by the housing 96 and extending through the main panel 46. The arm support shaft 98 is connected to the pin 84 and to the arm drive 94 such that pivoting of the arm support shaft by the arm drive 94 results in pivot of the display arm 82 with respect to the main panel 46 for the above-described lens wiping simulation. The mechanism 80 includes a rocker member 100 having an elongated tab 102 and spaced legs 104 respectively defined by upper and lower end portions of the rocker member 100. The mechanism also includes an elongated sleeve 106 that receives the arm support shaft 98 and extends through the rocker member 100 between the tab 102 and legs 104. The rocker member 100, sleeve 106 and arm support shaft 98 are connected to each other such that pivoting of the rocker member 100 by the mechanism 80 results in pivoting of the display arm 82 with respect to the main panel 46.

Referring to FIG. 6, the mechanism 80 is shown with portions of the housing 96 and the rocker member legs 104 removed. The arm drive 94 includes a pair of magnet elements 108 carried by the legs 104 of the rocker member 100 and a coil element 110. Referring to FIG. 5, the coil element 110 is supported by the housing 96 such that coil element 110 is substantially vertically aligned with the pivot axis defined by the shaft 98. The coil element 110 is also supported by the housing 96, as shown in FIG. 6, such that the coil element 110 is located between the magnet elements 108 carried by the rocker member 100 when the rocker member 100 is in the vertically aligned orientation shown in FIG. 5.

The rocker member 100 is preferably constructed such that a center of gravity of the rocker member 100 is located below the pivot axis defined by shaft 98. Arranged in such bottom-heavy manner, the rocker member 100 tends to swing to and fro under gravity action in a pendulum-like fashion, thereby moving the display arm to and fro to simulate a wiping motion of the display arm 82 with respect to the eyeglass lens portion 92 of the depiction 90 on the main panel 46. The tab 102 of rocker member 100, which is located above the pivot axis, provides a convenient place for a user to contact the rocker member 100 and initiate the above-described pendulum-like motion of the rocker member 100 and the display arm 82 that is connected to the rocker member.

The arm drive 94 of mechanism 80 operates in the following manner to maintain the above-described pendulum-like motion imparted to the rocker member 100, which would otherwise diminish and eventually stop. The coil element 110 and magnet elements 108 are arranged such that the magnet elements 108 tend to be repelled by the energized coil element 110. The magnetic interaction between the magnet elements 108 carried by the swinging rocker member 100 and the centrally located, and energized, coil element 110 maintains the rocker member 100 in a pendulum-like swinging motion that has a substantially constant amplitude.

Referring to FIGS. 5 and 6, the housing 96 includes a battery compartment 112 in which a battery 114 is received to provide the power source for energizing the coil element 110. The tab 102 extends beyond an upper end 116 of the housing 96 to facilitate contact of the tab 102 by a user for initiating swinging movement of the rocker member 100, as described above, from a neutral position of the rocker member 100 associated with an non-energized coil element 110.

As shown in FIG. 5, one of the rear flaps 52 of the advertising portion 24 of the display 10 preferably includes a housing support portion 118 preferably formed by cutting the rear flap 52. The housing support portion 118 of the rear flap 52 is folded to extend inwardly towards the main panel beneath the housing 96, thereby providing support for the mechanism 80.

The foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A display for an eyeglass wiping device, the device including a pair of wiping elements and a holder, the holder having a pair of arms connected to each other at one end and supporting the wiping elements adjacent an opposite end for contact between the wiping elements and opposite surfaces of an eyeglass lens, the display comprising:
an advertising panel including a front surface bearing a depiction of an eyeglass lens; and
a wiping illustration mechanism attached to the advertising panel, the wiping illustration mechanism including a display arm for simulating the eyeglass wiping device, the display arm including an elongated body portion and a head portion connected to the body portion, the display arm pivotably supported such that the head portion of the display arm is located adjacent the eyeglass lens depicted on the advertising panel, the wiping illustration mechanism also including an arm drive operably connected to the display arm and pivotably driving the display arm with respect to the advertising panel in a to and fro motion simulating a wiping motion of an eyeglass wiping device with respect to an eyeglass lens.

2. The display according to claim. 1, wherein the arm drive includes a rocker member supported for pivot with respect to a pivot axis and operably connected to the display arm such that the display arm pivots concomitantly with the rocker member.

3. The display according to claim 2, wherein the rocker member includes a pair of spaced legs located below the pivot axis and a magnet element carried by each of the legs, the arm drive further including an energizable coil element centrally supported between the spaced legs of the rocker member such that a magnetic interaction between the coil element and the magnet elements carried by the legs maintains the rocker member in a to and fro pivoting motion with respect to the advertising panel having a substantially constant amplitude.

4. The display according to claim 2, wherein the wiping illustration mechanism includes a housing secured to a rear surface of the advertising panel, the housing defining an interior in which at least a portion of the rocker member is located.

5. The display according to claim 4, wherein the rocker member includes an elongated tab located above the pivot axis, the tab extending beyond an upper end of the housing to facilitate contact of the tab by a user to initiate to and fro pivoting of the rocker member with respect to the advertising panel.

6. The display according to claim 3, wherein the wiping illustration mechanism includes a housing secured to a rear surface of the advertising panel, the housing defining an interior in which at least a portion of the rocker member is located, the housing further including a battery compartment in which a battery is receivable for providing a source of power for energizing the coil element.

7. The display according to claim 1 further comprising a tray engaging a lower edge of the advertising panel to support the panel, the tray also supporting packaging including eyeglass wiping devices secured to mounting panels, the tray supporting the mounting panels in a substantially upstanding orientation.

8. The display according to claim 7, wherein the advertising panel includes notches located along the lower edge of the panel, the notches receiving projections defined by the tray along a rearward end of the tray.

9. The display according to claim 7, wherein the tray includes at least one channel including opposite side walls, the sidewalls including spaced slots each receiving one of opposite side edges of a mount panel of the packaging.

10. The display according to claim 9, wherein the tray includes a plurality of projections extending from a lower surface of the channel each arranged to contact a rear side of one of the mount panels to forwardly bias the mount panel with respect to an associated pair of slots in which the panel is received.

11. The display according to claim 8, wherein the tray further includes a peripheral lip located at the rearward end of the tray for contact by the lower edge of the advertising panel.

12. The display according to claim 7 further comprising a pair of side flaps each connected to the advertising panel on one of opposite side edges of the advertising panel, and a pair of rear flaps each connected to one of the side flaps, the rear flaps secured to side flaps and rear flaps collectively defining with side flap connected to each of opposite sides of the advertising panel and flap connected to a rear surface of the advertising panel such that the side and rear flaps collectively define a pair of enclosed interiors in the form of open-ended boxes.

13. The display according to claim 12, wherein the arm drive includes a housing secured to the rear surface of the advertising panel such that at least a portion of the housing is located within one of the enclosed interiors defined by the advertising panel and the side and rear flaps.

14. A display for an eyeglass wiping device, the device including a pair of wiping elements and a holder, the holder having a pair of arms connected to each other at one end and supporting the wiping elements adjacent an opposite end for contact between the wiping elements and opposite surfaces of an eyeglass lens, the display comprising:
an advertising panel including a front surface bearing a depiction of an eyeglass lens; and
an eyeglass wiping illustration mechanism attached to the advertising panel, the mechanism including a display arm for simulating the eyeglass wiping device, the display arm including an elongated body portion and a head portion connected to the body portion, the display arm pivotably supported at a pivot axis such that the head portion of the display arm is located adjacent the eyeglass lens depicted on the advertising panel, the wiping illustration mechanism also including a rocker member pivotably supported at the pivot axis rearwardly of the advertising panel and operably connected to the rocker member such that the display arm pivots concomitantly with the rocker member, the rocker member having a center of gravity located below the pivot axis providing a to and fro pivoting motion of the rocker member in pendulum-like fashion.

15. The display according to claim 14, wherein at least a portion of the rocker member is located within an interior defined by a housing, the housing secured to a rear surface of the advertising panel.

16. The display according to claim 15, wherein the rocker member includes a tab located above the pivot axis and extending beyond an upper end of the housing to facilitate initiation of the to and fro pivoting motion of the rocker member.

17. The display according to claim 14, wherein the rocker member includes spaced legs located below the pivot axis, each of the legs of the rocker member carrying a magnet element for magnetic interaction between the magnet elements and an energized coil element, the magnet elements and the coil element arranged such that the magnetic interaction maintains the rocker member is a to a fro motion having a substantially constant amplitude.

18. A display for an eyeglass wiping device, the eyeglass wiping device including a pair of wiping elements and a holder, the holder having a pair of arms connected to each other at one end and supporting the wiping elements adjacent an opposite end for contact between the wiping elements and opposite surfaces of an eyeglass lens, the display comprising:
an advertising portion including a main panel having a front surface presenting a depiction of an eyeglass lens, the advertising portion also including a eyeglass wiping simulator having a display arm for simulating the wiping device, the display arm including an elongated body portion and a head portion connected to the body portion, the display arm supported for pivot about a pivot axis such that the head portion of the display arm is located adjacent the lens depicted on the front surface of the main panel to simulate a wiping motion of the eyeglass wiping device with respect to an eyeglass lens; and
a product support tray supporting the advertising portion of the display adjacent a rearward end of the tray, the tray defining at least one channel in an upper surface of the tray having opposite side walls, the opposite side walls of the channel including spaced slots each receiving one of opposite side edges of a packaging panel to which the eyeglass wiping device is mounted such that the packaging panel is oriented in a substantially upstanding orientation.

19. The display according to claim 18, wherein the advertising portion further includes a rocker member supported for pivot about the pivot axis, the rocker member operably connected to the display arm such that the display arm pivots concomitantly with the rocker member, the rocker member having a center of gravity located below the pivot axis such that the rocker member pivots in a to and fro motion in pendulum-like fashion.

20. The display according to claim 19, wherein the rocker member includes spaced legs located below the pivot axis, each of the legs of the rocker member carrying a magnet element for magnetic interaction between the magnet elements and an energized coil element, the magnet elements and the coil element arranged such that the magnetic interaction maintains the rocker member is a to a fro motion having a substantially constant amplitude.
